(19) United States
(12) Patent Application Publication
(10) Pub. No.: US 2006/0262042 A1
(43) Pub. Date: Nov. 23, 2006

(54) Method of driving plasma display panel (PDP)

(76) Inventors: Jae-Ik Kwon, Suwon-si (KR); Kyoung-Doo Kang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/406,009

(22) Filed: Apr. 18, 2006

(30) Foreign Application Priority Data
May 19, 2005 (KR) 10-2005-0042173

(51) Int. Cl. G09G 3/28

(52) U.S. Cl. 345/67

(57) ABSTRACT

A method of driving a plasma display panel (PDP), and a PDP are disclosed. The PDP includes discharge cells, each cell formed in a region where an address electrode crosses pairs of inner and outer sustain electrodes. The method of driving the PDP includes driving the inner sustain electrodes, so as to substantially prevent cross talk between neighboring discharge cells.

### CROSS-REFERENCE TO RELATED APPLICATIONS

This application claims the benefit of Korean Patent Application No. 10-2005-0042173, filed on May 19, 2005, in the Korean Intellectual Property Office, the disclosure of which is incorporated herein in its entirety by reference.

### BACKGROUND OF THE INVENTION

1. Field of the Invention

The present invention relates to a method of driving a plasma display panel (PDP), and more particularly, to a method of driving a PDP having a new structure that a discharge cell includes two or more discharge spaces in which each of frame of the PDP includes a plurality of sub-fields for displaying time-division gradation where the time-division gradation and is divided into a reset period, an address period, and sustain discharge periods.

2. Description of the Related Technology

A plasma display panel (PDP) which is a flat display devices can be easily manufactured and scaled-up. The PDP displays images using a discharge phenomenon and is classified as a DC type or an AC type, according to driving voltage waveforms. The AC type PDP is commonly developed since the DC type PDP has a long discharge delay time.

A typical AC type PDP is a three electrode AC surface discharge type PDP that includes three electrodes and is driven by an AC voltage. Since a conventional three electrode AC surface discharge type PDP is generally formed of multiple substrates and provides a thin, light, and wide screen, it is advantageous over an other screen display device such as, a cathode ray tube (CRT), in terms of space usage.

As an example of a conventional PDP that is a three electrode AC surface discharge type PDP, an apparatus and method for driving the PDP are disclosed in U.S. Pat. No. 6,744,218 entitled “Method of Driving a Plasma Display Panel in which the Width of Display Sustain Pulse Varies” in the same name of the applicant of the present invention.

The PDP includes a plurality of display cells, each of them including three (red, green, and blue) discharge cells and displaying image gradation according to the discharge state of the discharge cells.

A frame applied to the PDP has eight sub-fields, each having a different light-emitting frequency to display 256 gradations of the PDP. To be more specific, when the PDP displays an image with 256 gradations, a frame duration (16.67 ms) corresponding to a 1/60 second is classified as eight sub-fields.

Each of the sub-fields is divided into a reset period that generates discharges, an address period that selects a display cell, and a sustain discharge period that displays gradations according to a discharge frequency. Each of the sub-fields has the same period equal to the sum of the reset period, the address period, and a different sustain discharge period. The number of discharge pulses generated in the sustain discharge period of each of the sub-fields may be any of 1, 2, 4, 8, 16, 32, and 128. The number of discharge pulses determines the discharge frequency of discharge cells. As such, the PDP can display 256 gradation levels of an image by controlling the discharge frequency of the sustain discharge period of each of the sub-fields.

### SUMMARY OF THE CERTAIN INVENTIVE ASPECTS

The present invention provides a method of driving a PDP having a new structure such that a discharge cell includes two or more discharge spaces, wherein a scan voltage is not applied to outermost scan electrodes from scan electrodes, and cross talk between neighboring discharge cells is prevented.

One embodiment is a method of driving a plasma display panel (PDP), where the PDP includes a plurality of discharge cells defining a display unit, each discharge cell being formed in a region where an address electrode crosses one or more pairs of inner sustain electrodes and crosses one or more pairs of outer sustain electrodes. Also, each pair of inner and outer sustain electrodes includes a common electrode and a scan electrode. The method includes driving the PDP during each of a plurality of sub-fields in a unit frame time according to a gradation weight so as to display time-division gradations, where the plurality of sub-fields includes a reset period, an address period, and a sustain discharge period. The method also includes driving an inner scan electrode of a pair of inner sustain electrodes of a discharge cell during the address period with an active voltage while maintaining a outer scan electrode of a pair of outer sustain electrodes of the a discharge cell at an inactive voltage during the address period.

Another embodiment is a method of driving a plasma display panel (PDP), where the PDP includes a plurality of discharge cells defining a display unit, and each discharge cell includes one or more pairs of inner sustain electrodes and one or more pairs of outer sustain electrodes. Also, each pair of inner and outer sustain electrodes includes a common electrode and a scan electrode. The method includes driving an inner scan electrode of a pair of inner sustain electrodes of a discharge cell during a period with an active voltage, and maintaining an outer scan electrode of a pair of outer sustain electrodes of the discharge cell at an inactive voltage during the period.

Another embodiment is a plasma display panel (PDP) device including a plurality of discharge cells defining a display unit, each discharge cell including one or more pairs of inner sustain electrodes and one or more pairs of outer sustain electrodes, where each pair of inner and outer sustain electrodes includes a common electrode and a scan electrode. The device also includes a driving circuit configured to drive an inner scan electrode of a pair of inner sustain electrodes of a discharge cell during a period with an active voltage, and maintain an outer scan electrode of a pair of outer sustain electrodes of the discharge cell at an inactive voltage during the period.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a plasma display panel (PDP) having a new structure to which a method of driving the PDP is applied;

FIG. 2 is a schematic cross-sectional view of the PDP taken along a line II-II in FIG. 1;

FIG. 3 is a schematic cross-sectional view of the PDP taken along a line III-III in FIG. 1;

FIG. 4 is a block diagram of an apparatus configured to drive an embodiment of a PDP;

FIG. 5 is a timing diagram illustrating the method of driving the PDP in which a unit frame is classified as 8 sub-fields according to one embodiment; and

FIG. 6 is a timing diagram of driving signals applied to electrode lines that form consecutive scan lines in the PDP according to one embodiment.

### DETAILED DESCRIPTION OF CERTAIN INVENTIVE EMBODIMENTS

Certain inventive embods will now be described more fully with reference to the accompanying drawings, in which example embodiments of the invention are shown.

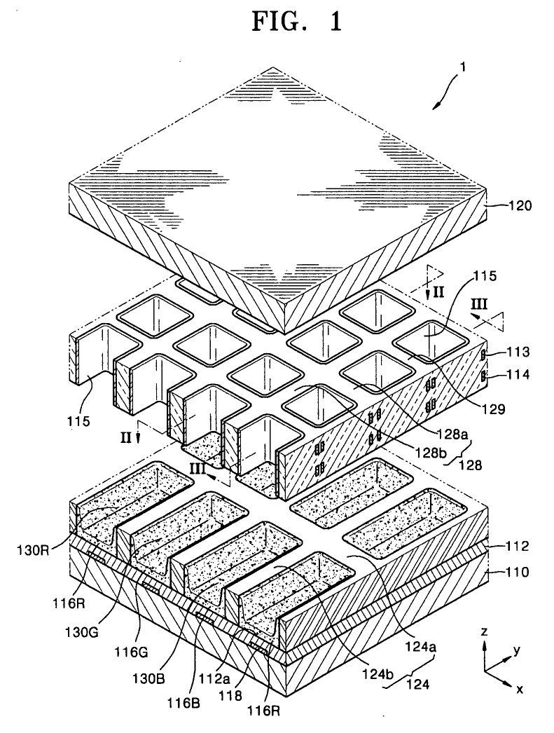

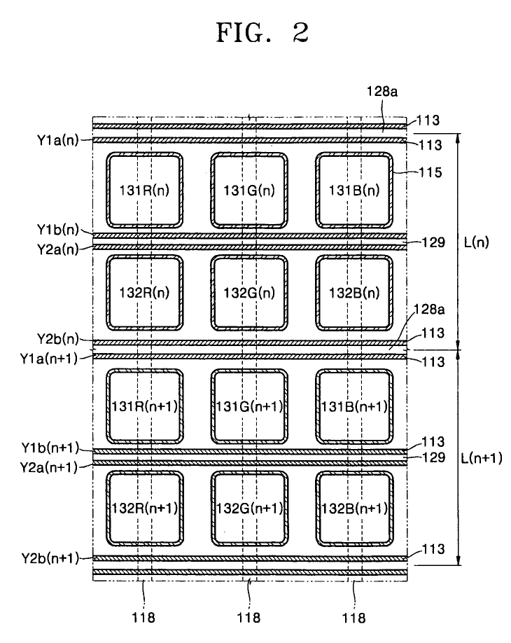

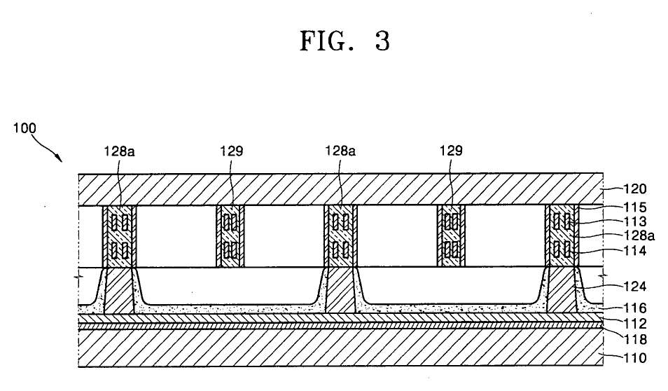

FIG. 1 is an exploded perspective view of a plasma display panel (PDP) having a new structure to which a method of driving the PDP according to an embodiment is applied. FIG. 2 is a schematic cross-sectional view of the PDP taken along a line II-II in FIG. 1. FIG. 3 is a schematic cross-sectional view of the PDP taken along a line III-III in FIG. 1

Referring to FIGS. 1 through 3, the PDP 1 includes a front substrate 120, a rear substrate 110, barrier ribs 124 and 128, discharge electrodes 113, 114, and 118, and phosphor layers 116R, 116G, and 116B. The front substrate 120 and the rear substrate 110 are disposed to be spaced by a gap from each other. The barrier ribs 124 and 128 which are made of dielectric layers are disposed between the front substrate 120 and the rear substrate 110 and partition discharge cells 130R, 130G, and 130B. The discharge electrodes 113, 114, and 118 are disposed to be spaced from one another between the front substrate 120 and the rear substrate 110 and are configured to generate discharges in discharge spaces formed in each of the discharge cells 130R, 130G, and 130B when a supply voltage is supplied thereto. The phosphor layers 116R, 116G, and 116B are formed in each of the discharge cells 130R, 130G, and 130B. Discharge gas is charged in the discharge cells 130R, 130G, and 130B.

As shown in FIG. 1, the PDP according to this embodiment has two or more discharge spaces in the discharge cells 130R, 130G, and 130B. The barrier ribs 124 and 128 include a front barrier rib 128 and a rear barrier rib 124 formed between the rear substrate 110 and the front substrate 110. An MgO protection film may be formed on the surface toward the inside of a discharge cell of the front barrier rib 128. Other materials may also be used.

The discharge electrodes 113, 114, and 118 include a front discharge electrode 113 and a rear discharge electrode 114 which are parallel so as to be spaced from one another in a direction from the front substrate 120 to the rear substrate 110. The front discharge electrode 113 and the rear discharge electrode 114 are formed inside the barrier ribs 124 and 128, e.g., the front barrier rib 128 of the embodiment of FIG. 1. An address electrode 118 is formed so as to cross the front discharge electrode 113 and the rear discharge electrode 114. The address electrode 118 is formed on the rear substrate 110 and a dielectric layer 112 is formed to cover the address electrode 118. The front barrier rib 128 includes horizontal front barrier ribs 128a in an X direction and vertical front barrier ribs 128b in a Y direction. The front discharge electrode 113 and the rear discharge electrode 114 may be formed to extendin the X direction along the inside of the horizontal front barrier ribs 128a.

In a method of driving the PDP, the front discharge electrode 113 may be a common electrode, and the rear discharge electrode 114 may be a scan electrode. Accordingly, when activated, the scan electrode 114 efficiently generates an address discharge because of the electric field generated between the scan electrode 114 and the address electrode 118.

The rear barrier rib 124 includes horizontal rear barrier ribs 124a formed in a direction parallel to the horizontal front barrier ribs 128a and a vertical rear barrier rib 124b formed in a direction parallel to the vertical front barrier ribs 128b. In this embodiment, the horizontal front barrier ribs 128a are disposed corresponding to the horizontal rear barrier ribs 124a and the vertical front barrier ribs 128b are disposed corresponding to the vertical rear barrier rib 124b to form the discharge cells 130R, 130G, and 130B.

The PDP includes a plurality of display pixels, each of them including the red, green, and blue discharge cells 130R, 130G, and 130B according to phosphors forming the phosphor layers 116R, 116G, and 116B and displaying image gradation according to the discharge state of the discharge cells 130R, 130G, and 130B. The horizontal front barrier ribs 128a that partition each of the discharge cells 130R, 130G, and 130B further include separate horizontal front barrier ribs 129 so as to form two or more discharge spaces in each of the discharge cells 130R, 130G, and 130B. To be more specific, the separate horizontal front barrier ribs 129 are formed between the horizontal front barrier ribs 128a in a region partitioned by the horizontal rear barrier ribs 124a and the horizontal front barrier ribs 128a.

Front discharge electrodes 113 and rear discharge electrodes 114 which generate discharges in each of the neighboring discharge cells can be disposed inside the horizontal front barrier ribs 128a. Front discharge electrodes 113 and rear discharge electrodes 114 can also be disposed inside the separate horizontal front barrier ribs 129.

Referring to FIG. 2, a red discharge cell may include two discharge spaces 131R and 132R separated by the separate horizontal front barrier ribs 129 and be identically driven. Likewise, a green discharge cell includes two discharge spaces 131G and 132G separated by the separate horizontal front barrier ribs 129, and a blue discharge cell includes two discharge spaces 131B and 132B separated by the separate horizontal front barrier ribs 129. Discharge cells that form consecutive scan lines L(n) and L(n+1) and the scan electrodes 113 that generate discharge in the discharge cells are illustrated in FIG. 2. The scan line L(n) includes 131R(n), 131G(n), 131B(n), 132R(n), 132G(n), 132B(n), and scan electrodes Y1a(n), Y1b(n), Y2a(n), and Y2b(n). The scan line L(n+1) includes 131R(n+1), 131G(n+1), 131B(n+1), 132R(n+1), 132G(n+1), 132B(n+1), and scan electrodes Y1a(n+1), Y1b(n+1), Y2a(n+1), and Y2b(n+1). In this regard, the scan electrodes Y1a(n), Y2b(n), Y1a(n+1), and Y2b(n+1) are outermost scan electrodes corresponding to each of the discharge cells.

FIG. 3 is a schematic cross-sectional view of the PDP taken along a line III-III in FIG. 1. As seen, each discharge cell has outer sustain electrodes 128a on either side, and inner sustain electrodes 129 between the outer sustain electrodes 128a.

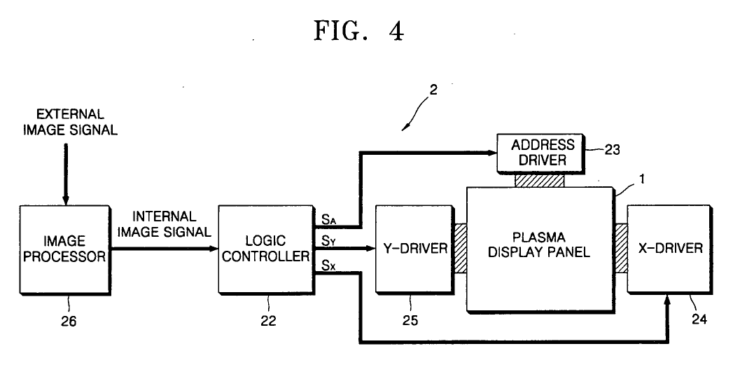

FIG. 4 is a block diagram of an apparatus configured to drive an embodiment of a PDP; Referring to FIG. 4, the apparatus 2 for driving the PDP 1 includes an image processor 26, a logic controller 22, an address driver 23, an X driver 24, and a Y driver 25. The image processor 26 converts an external analog image signal into a digital signal and generates internal image signals, e.g., 8-bit red (R), green (G), and blue (B) image data, a clock signal, and vertical and horizontal synchronization signals. The logic controller 22 generates driving control signals S_{A}, S_{Y}, and S_{X} according to the internal image signals generated by the image processor 26.

The address driver 23, the X driver 24, and the Y driver 25 receive the driving control signals S_{A}, S_{Y}, and S_{X} generated by the logic controller 22, generate their respective driving signals, and apply the generated driving signals to each of the electrode lines. The address driver 23 processes the address driving control signal S_{A} from the driving control signals S_{A}, S_{Y}, and S_{X}, generates a display data signal, and applies the generated display data signal to address electrode lines. The X driver 24 processes the X driving control signal S_{X} from the driving control signals S_{A}, S_{Y}, and S_{X} and applies the processed X driving control signal S_{X} to X electrode lines. The Y driver 25 processes the Y driving control signal S_{Y} from the driving control signals S_{A}, S_{Y}, and S_{X} and applies the processed Y driving control signal S_{Y} to Y electrode lines.

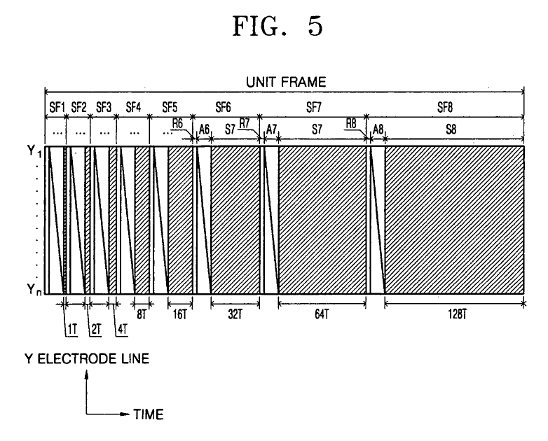

FIG. 5 is a timing diagram for explaining the method of driving the PDP in which a unit frame is classified as 8 sub-fields according to an embodiment of the present invention.

Referring to FIG. 5, the unit frame time is classified as 8 sub-fields SF1 through SF8 in order to achieve time-division gradation display. Also, each of the sub-fields SF1 through SF8 is divided into a reset period R1 through R8, an address period A1 through A8, and a sustain discharge period S1 through S8. The brightness of the PDP is proportional to the total length of the sustain discharge period S1 through S8 in the unit frame. The total length of the sustain discharge period S1 through S8 in the unit frame is 255 T (T denotes unit time). In this case, time corresponding to 2ⁿ is the duration of each of the sustain discharge periods Sn of an n^{th} sub-field SFn. Therefore, if a sub-field is selected from the 8 sub-fields, 256 gradation including zero gradation which is not displayed in any sub-field can be displayed.

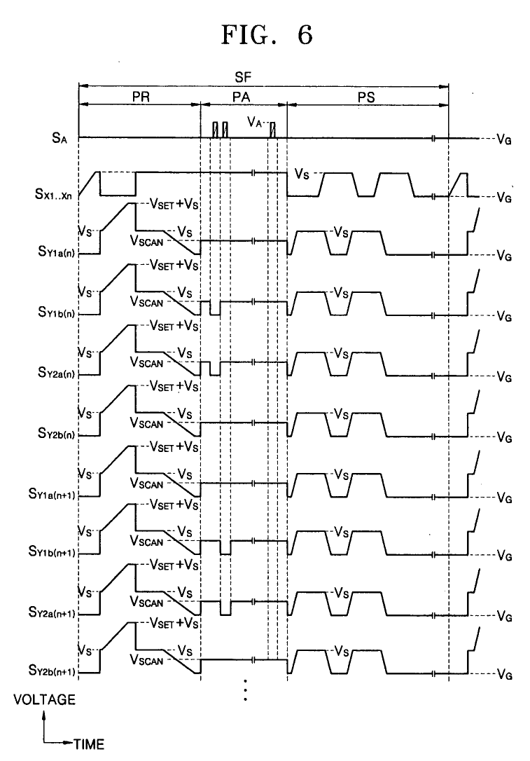

FIG. 6 is a timing diagram of driving signals applied to electrode lines that form consecutive scan lines in the PDP according to one embodiment.

Referring to FIG. 6, a reference numeral SA indicates driving signals applied to each of the address electrode lines (118 of FIG. 1), reference numerals S_{X1}-S_{Xn} indicate driving signals applied to each of the common electrode lines (113 of FIG. 1), and reference numerals S_{Y1}-S_{Yn} indicate driving signals applied to each of the scan electrode lines (114 of FIG. 1). In this embodiment, the common electrode lines 113 are the X electrode lines and the scan electrode lines 114 are the Y electrode lines.

In a reset period PR of a unit sub-field SF, a voltage applied to the X electrode lines 113 is raised from a ground voltage V_{G} to a second voltage V_{S}, e.g., 155 volts V. The ground voltage V_{G} is applied to the Y electrode lines 114 and the address electrode lines 118. Therefore, a weak discharge is generated between the X electrode lines 113 and the Y electrode lines 114 and between the X electrode lines 113 and the address electrode lines 118 to form negative wall charges around the X electrode lines 113.

A voltage applied to the Y electrode lines 114 is raised from the second voltage V_{S}, e.g., 155 volts V, to the maximum voltage V_{SET}+V_{S} higher than the second voltage V_{S} by a third voltage V_{SET}, e.g., 355 volts V. The ground voltage V_{G} is applied to the X electrode lines 113 and the address electrode lines 118. Therefore, a weak discharge is generated between the Y electrode lines 114 and the X electrode lines 113, and a weaker discharge than the discharge generated between the Y electrode lines 114 and the X electrode lines 113 is generated between the Y electrode lines 114 and the address electrode lines 118.

Next, while the voltage applied to the X electrode lines 113 is maintained at the second voltage V_{S}, the voltage applied to the Y electrode lines 114 is lowered from the second voltage V_{S} to the ground voltage V_{G}. The ground voltage V_{G} is applied to the address electrode lines 118.

In an address period PA, the display data signal of an address pulse is applied to the address electrode lines 118, and scan signals of a scan pulse having the ground voltage V_{G} are sequentially applied to the Y electrode lines 114 which are biased as a fourth voltage V_{SCAN} lower than the second voltage V_{S}, thereby performing an addressing operation.

If a discharge cell is selected, the display data signal having a positive address voltage V_{A} is applied to the address electrode lines 118. If not, the display data signal having the ground voltage V_{G} is applied to the address electrode lines 118. Therefore, while the scan pulse having the ground voltage V_{G} is applied, a discharge cell to which the display data signal having the positive address voltage V_{A} is applied generates an address discharge and forms wall charges, and a discharge cell to which the display data signal having the ground voltage V_{G} is applied does not generate address discharge and form wall charges. Also, as described above, the second voltage V_{S} is applied to the X electrode lines 113 to more accurately and effectively generate the address discharge.

In this embodiment, in the address period PA, the scan pulse is not applied to the outermost scan electrodes Y1a(n), Y2b(n), Y1a(n+1), and Y2b(n+1). That is, in the address period PA, voltages of the outermost scan electrodes Y1a(n), Y2b(n), Y1a(n+1), and Y2b(n+1) are maintained at the fourth voltage V_{SCAN} lower than the second voltage V_{S} that does not generate the address discharge in address electrodes. To be more specific, the scan pulse is not applied to the outermost scan electrodes, the address discharge is not generated between address electrodes and the outermost scan electrodes but in the scan electrodes Y1b(n), Y2a(n), Y1b(n+1), and Y2a(n+1) of FIG. 2. As a result, an unintended address discharge is not generated in neighboring discharge cells, such that cross talk is substantially prevented.

In a sustain discharge period PS, display sustain pulses having the second voltage Vs are alternately applied to the Y electrode lines 114 and the X electrode lines 113 to generate a display sustain discharge in the discharge cells at which wall charges are formed during the address period PA. In some embodiments only scan signals corresponding to scan electrodes Y1b(n), Y2a(n), Y1b(n+1), and Y2a(n+1) as illustrated in FIGS. 1, 2, 3, and 7, are supplied. However, embodiments are not restricted thereto, and the scan electrodes Y1b(n) and Y2a(n) may be connected and the scan electrodes Y1b(n+1) and Y2a(n+1) may be connected so as to apply the same driving signal thereto. That is, among the scan electrodes included in one discharge cell, the scan electrodes other than the outermost scan electrodes can be connected.

Accordingly, a method of driving the PDP having a new structure that a discharge cell includes two or more discharge spaces does not apply a scan voltage to outermost scan electrodes of discharge cells and can, therefore, prevent cross talk between neighboring discharge cells and erroneous discharge due to the cross talk.

While the present invention has been particularly shown and described with reference to embodiments thereof, it will be understood by those of ordinary skill in the art that various changes in form and details may be made therein without departing from the spirit and scope of the present invention.

What is claimed is:

1. A method of driving a plasma display panel (PDP), wherein the PDP comprises a plurality of discharge cells defining a display unit, each discharge cell being formed in a region where an address electrode crosses one or more pairs of inner sustain electrodes and crosses one or more pairs of outer sustain electrodes, each pair of inner and outer sustain electrodes comprising a common electrode and a scan electrode, the method comprising:
driving the PDP during each of a plurality of sub-fields in a unit frame time according to a gradation weight so as to display time-division gradations, wherein the plurality of sub-fields comprises a reset period, an address period, and a sustain discharge period; and
driving an inner scan electrode of a pair of inner sustain electrodes of a discharge cell during the address period with an active voltage while maintaining a outer scan electrode of a pair of outer sustain electrodes of the a discharge cell at an inactive voltage during the address period.

2. The method of claim 1, wherein the inactive voltage has a higher magnitude than a maximum voltage magnitude required to generate an address discharge.

3. The method of claim 1, wherein the active voltage has a lower magnitude than a maximum voltage magnitude required to generate an address discharge, and wherein, prior to driving the inner scan electrode with the active voltage, the inner and outer scan electrodes are driven to the inactive voltage.

4. The method of claim 3, wherein the inactive voltage has a magnitude lower than a voltage of a sustain pulse applied to the inner scan electrode during a sustain discharge period.

5. The method of claim 3, wherein the active voltage is a ground level.

6. The method of claim 3, further comprising:
driving an address electrode of the a discharge cell with a discharge voltage, wherein a discharge between the inner scan electrode and the address electrode is generated; and
driving an address electrode of an other discharge cell with an idle voltage, wherein a discharge between a scan electrode and the address electrode of the other discharge cell is not generated.

7. The method of claim 6, wherein the discharge voltage is positive.

8. The method of claim 6, wherein the idle voltage is a ground voltage.

9. A method of driving a plasma display panel (PDP), wherein the PDP comprises a plurality of discharge cells defining a display unit, each discharge cell comprising one or more pairs of inner sustain electrodes and one or more pairs of outer sustain electrodes, each pair of inner and outer sustain electrodes comprising a common electrode and a scan electrode, the method comprising:
driving an inner scan electrode of a pair of inner sustain electrodes of a discharge cell during a period with an active voltage; and
maintaining an outer scan electrode of a pair of outer sustain electrodes of the discharge cell at an inactive voltage during the period.

10. The method of claim 9, wherein the discharge cells are each formed in a region where an address electrode crosses one or more pairs of inner sustain electrodes and crosses one or more pairs of outer sustain electrodes.

11. The method of claim 10, further comprising driving the PDP during a plurality of unit frame times, each unit frame time comprising a plurality of sub-fields, wherein each sub-field comprises:
a reset period, during which a discharge is generated in each of the discharge cells, wherein the discharge is substantially identical to discharges generated in each of the other sub-fields;
an address period, during which discharge cells are selected according to display data; and
a sustain discharge period, during which the discharge of selected discharge cells is sustained.

12. The method of claim 11, wherein the inactive voltage has a higher magnitude than a maximum voltage magnitude required to generate an address discharge.

13. The method of claim 11, wherein the active voltage has a lower magnitude than a maximum voltage magnitude required to generate an address discharge, and wherein, prior to driving the inner scan electrode with the active voltage, the inner and outer scan electrodes are driven with the inactive voltage.

14. The method of claim 11, further comprising:
driving an address electrode of the discharge cell with a discharge voltage, wherein a discharge between the inner scan electrode and the address electrode is generated; and
driving an address electrode of an other discharge cell with an idle voltage, wherein a discharge between a scan electrode and the address electrode of the other discharge cell remains ungenerated.

15. An apparatus configured to drive a PDP according to the method of claim 1.

16. An apparatus configured to drive a PDP according to the method of claim 9.

17. A plasma display panel (PDP) device comprising:
a plurality of discharge cells defining a display unit, each discharge cell comprising one or more pairs of inner sustain electrodes and one or more pairs of outer sustain electrodes, each pair of inner and outer sustain electrodes comprising a common electrode and a scan electrode; and
a driving circuit configured to:
drive an inner scan electrode of a pair of inner sustain electrodes of a discharge cell during a period with an active voltage; and
maintain an outer scan electrode of a pair of outer sustain electrodes of the discharge cell at an inactive voltage during the period.

18. The device of claim 17, wherein the driving circuit is further configured to drive the PDP during unit frame times, each unit frame time comprising a plurality of sub-fields, wherein each sub-field comprises:
a reset period, during which a discharge is generated in each of the discharge cells, wherein the discharge is substantially identical to discharges generated in each of the other sub-fields;
an address period, during which discharge cells are selected according to display data; and
a sustain discharge period, during which the discharge of selected discharge cells is sustained.

19. The device of claim 17, wherein the inactive voltage has a higher magnitude than a maximum voltage magnitude required to generate an address discharge.

20. The device of claim 17, wherein the active voltage has a lower magnitude than a maximum voltage magnitude required to generate a discharge cell discharge, and wherein, the driving circuit is configured to drive the inactive voltage with the first and second electrodes prior to driving the inner scan electrode with the active voltage.
